(19) United States
(12) Patent Application Publication
(10) Pub. No.: US 2025/0181043 A1
(43) Pub. Date: Jun. 5, 2025

(54) Method and Control System for a Technical Installation

(71) Applicant: Siemens Aktiengesellschaft, Muenchen (DE)

(72) Inventor: Benjamin LUTZ, Pfinztal (DE)

(21) Appl. No.: 18/845,018

(22) PCT Filed: Mar. 9, 2023
(86) PCT No.: PCT/EP2023/056013

§ 371 Date: Sep. 9, 2024

(30) Foreign Application Priority Data
Mar. 10, 2022 (EP) 22161338.3

(51) Int. Cl. G05B 15/02

(52) U.S. Cl. CPC G05B 15/02

(57) ABSTRACT

The invention relates to a control system (9) for a technical installation. The control system comprises an operator station server (3) and an operator station client (2) which is connected to the server, wherein the server (3) transmits visualisation information to the client (2), and wherein the client (2) generates a graphical display (1) for an operator by means of the visualisation information, and wherein the client (2) accepts a request for a modification of the display (1) from the operator and transmits said request to the server (3), and wherein the server (3) stores the request received by the client (2) in a memory (16) of the server (3). The operator station client (2) accepts a condition, which can be specified by the operator, for applying the modification of the graphical display (1) and transmits it to the server (3), wherein the server (3) stores the condition in the memory (16) of the server (3).

### CROSS-REFERENCE TO RELATED APPLICATIONS

This is a U.S. national stage of application No. PCT/EP2023/056013 filed 9 Mar. 2023. Priority is claimed on European Application No. 22161338.3 filed 10 Mar. 2022, the content of which is incorporated herein by reference in its entirety.

### BACKGROUND OF THE INVENTION

### 1. Field of the Invention

The invention relates to a control system for a technical installation, in particular a production or process installation and relates to a method for operating the control system of the technical installation.

### 2. Description of the Related Art

For operator control and monitoring of technical installations, operators can optimize their activity and configure their workflows more efficiently via personalization. One possibility of personalization involves what are known as user selections, via which at runtime faceplate groups, trend displays and/or filtered subsequent message displays can be assembled, persisted and if necessary also retrieved again. User selections represent a runtime functionality but do not require previous engineering or project planning and can be configured and maintained flexibly at runtime by the operators.

If a situation occurs for which an operator has created a user selection, according to the prior art he must first identify the situation, (for example, perceive a specific alarm), recall that a user selection exists for the situation, and identify, find and open the one user selection from many. This inefficient procedure is also the reason why the potential of user selections at runtime could previously not be fully utilized by operators.

EP 3 876 046 A1 discloses a control system of a technical installation, which enables an adjustment of a display of visualization information performed by an operator station client via an operator at a runtime of the technical installation.

### SUMMARY OF THE INVENTION

It is an object of the invention is to provide a control system for a technical installation, which increases the efficiency of operator control and monitoring of the technical installation.

This and other objects and advantages are achieved in accordance with the invention by a control system for a technical installation and by a method for operating the control system of the technical installation, where the control system comprises at least one operator station server and at least one operator station client connected to the operator station server. Here, the operator station server is configured to transmit visualization information to the operator station client. The operator station client is configured to generate a graphical display for the operator of the technical installation via the visualization information, and the operator station client is configured to accept a request for a modification of the graphical display from the operator and to transmit the request to the operator station server. The operator station server is further configured to store the request received by the operator station client in a memory of the operator station server.

The operator station client of the inventive control system is additionally configured to accept a condition that can be specified by the operator for the application of the modification of the graphical display and to transmit the condition to the operator station server. The operator station server is configured to store the condition in the memory of the operator station server.

The technical installation can be an installation from the process industry, such as a chemical, pharmaceutical, petrochemical or an installation from the food and beverage industry. Any installations from the production industry, factories, in which, for example cars, or products of all types are produced, are also included here. Technical installations that are suited to implementing the inventive method can also come from the field of power generation. Windmills, solar plants or power stations for power generation are likewise included in the term technical installation.

In the present context, a control system is understood to mean a computer-assisted, technical system, which comprise functionalities for displaying, operating and controlling the process installation. The control system can also comprise sensors for determining measured values and different actuators. Moreover, the control system can comprise what are known as process and manufacturing components that are used to actuate the actuators or sensors. Furthermore, the control system can have inter alia means for visualizing the process installation and for engineering purposes. The control system can optionally also comprise further computing units for more complex controllers and systems for data storage and processing.

An “operator station server” is currently understood to mean a server that detects data of an operator control and monitoring system and generally alarm and measured value archives of a control system of a technical installation centrally and makes it available to users, where the operator station server should be understood to include processor and memory. The operator station server generally establishes a communication link to automation systems of the technical installation and forwards data from the technical installation to what are known as operator station clients, which are used for operator control and monitoring of operation of the individual functional elements of the technical installation.

The operator station server can have client functions in order to access the data (archives, messages, tags, variables) of other operator station servers.

As a result, images of an operation of the technical installation on the operator station server can be combined with variables of other operator station servers (server-server communication. The operator station server can be, but is not limited to, a SIMATIC PCS 7 industrial workstation server by the company Siemens.

An operator of the technical installation can access the operator station server via the operator station client, which can be a tablet, a smartphone, a personal computer or suchlike, for instance, for the purpose of operator control and monitoring of the technical installation.

By way of example, a modification of the graphical display can be the superimposition of a graphical window with a course of measured data from the technical installation, with an image of a monitoring camera, with a visualization of technical objects of the technical installation or suchlike. Likewise, the modification can lie in the targeted fading-out of specific areas of the graphical display to render concealed graphical objects immediately visible to the operator.

The operator station client of the inventive control system not only accepts the requirement of the operator to undertake a modification but it also accepts a condition for the application of this modification and stores it in the memory of the operator station server. This information specified by the operator can be used by the control system or by additional, external computing units in order to perform the modification in a targeted manner when the specified condition exists.

The operator station client is preferably configured, in the event that the condition is fulfilled, to automatically perform the modification of the graphical display. The control system overcomes the disadvantages of conventional control systems cited in the introductory part of the instant disclosure and can contribute to the potential of individual modifications of the graphical display possibly being fully utilized for operators.

The operator station server is particularly preferably configured to automatically check whether the condition is fulfilled and, in the event that the condition is fulfilled, to notify the operator station client to that effect. This can then, as previously mentioned, automatically perform the modification of the graphical display. In order to check whether the condition is fulfilled, the operator station server can access data from the technical installation, which is explained in more detail using the exemplary embodiment.

The graphical display can represent an installation image of the technical installation. In the event of a process installation, such an installation image can comprise for instance graphical representations of pumps, valves, tanks, pipelines, combustion chambers or suchlike. Here, the graphical representations can comprise current process measured values, status values, and/or (alarm) messages.

Within the scope of an advantageous embodiment of the invention, the condition represents an event, where the operator station client is configured to perform the modification of the graphical display when the event occurs. The condition can also result from a logical linking of a plurality of events. This means that the condition is fulfilled if an event A, an event B and an event C occur, for instance.

In this regard, an event can represent an opening of an installation image, an opening of a faceplate of a technical object of the technical installation, an occurrence of an alarm, a parameter change to a technical object of the technical installation, an operating state of a technical object of the technical installation, achieving a specific state of a sequence of steps to be worked through by the technical installation or achieving a specific quality criterion during operation of the technical installation.

The condition can alternatively or in addition also represent an identity, a role or a location of an operator operating the operator station client. When an operator registers with the operator station client within a specific region of the technical installation, for instance, a specific modification of the standard graphical display can automatically be displayed to him/her, in order to satisfy special requirements of the specific region (such as special environmental conditions). An identity or a role of an operator can also represent a condition (possibly in addition to the conditions/events already mentioned), which must be fulfilled for the modification of the graphical display. A “role” here can mean that in exerting his/her role the operator in question is entitled to specific functional rights which, if applicable, do not permit a specific modification of the graphical display. These functional rights generally relate to operator control and monitoring of specific components of the technical installation. By way of example, monitoring rights for some components and operating rights for other components can be assigned to a first operator, whereas monitoring and operator control rights are assigned to a second operator for all components.

The objects and advantages are moreover achieved in accordance with the invention by a method for operating a control system of a technical installation, in particular production and process installation, which comprises at least one operator station server and at least one operator station client, where the operator station server is configured to transmit visualization information to the operator station client, and where the operator station client is configured to generate a graphical display for an operator of the technical installation via the visualization information. The method comprises:
a) accepting a request for a modification of the graphical display and a condition for the application of the modification from an operator of the technical installation via the operator station client,
b) transmitting the request and the condition from the operator station client to the operator station server,
c) storing the request and the condition in a memory of the operator station server.

The operator station client can perform the modification of the graphical display automatically in the event that the condition is fulfilled.

Furthermore, the operator station server can automatically check whether the condition is fulfilled, and in the event that the condition is fulfilled, notify the operator station client to that effect.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The afore-described properties, features and advantages of this invention as well as the manner in which these are achieved will become clearer and more intelligible in conjunction with the following description of exemplary embodiments, which are explained in more detail in conjunction with the drawings, in which:

FIG. 1 shows a graphical display of a technical installation in accordance with a first aspect;

FIG. 2 shows a graphical display of a technical installation in accordance with a second aspect;

FIG. 3 shows a graphical display of a technical installation in accordance with a third aspect;

FIG. 4 shows an inventive control system in a schematic representation; and

FIG. 5 is a flowchart of the inventive method.

### DETAILED DESCRIPTION OF THE EXEMPLARY EMBODIMENTS

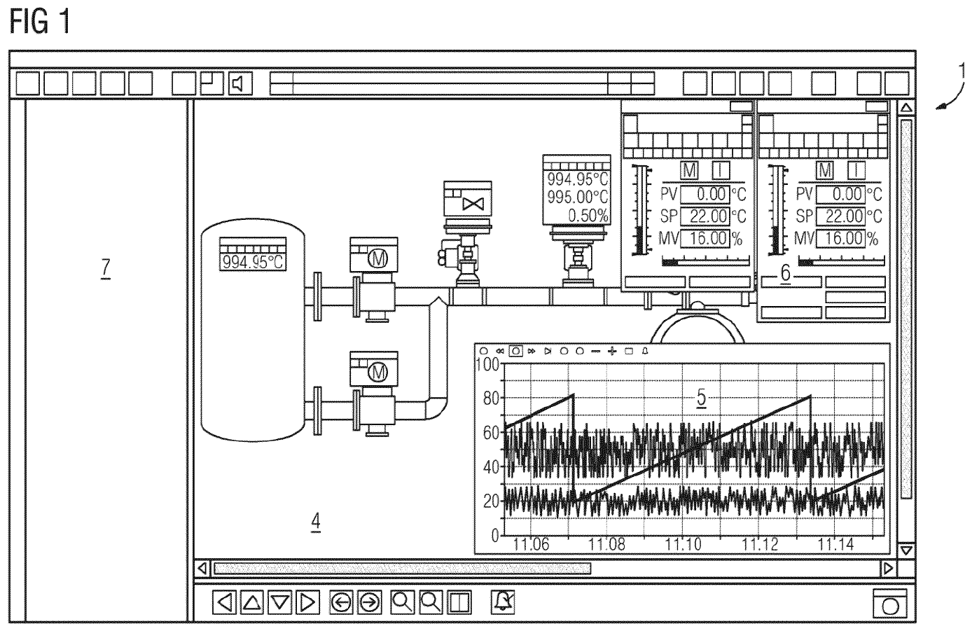

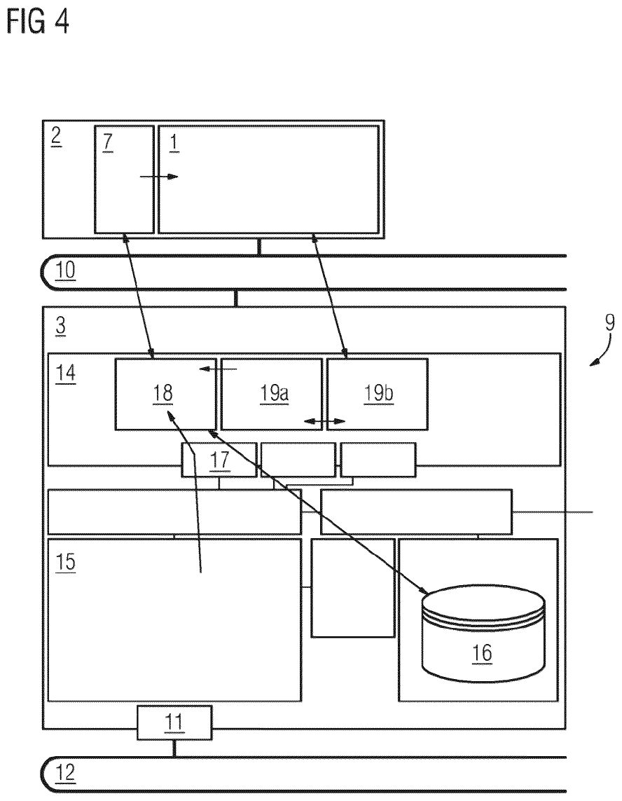

A graphical user interface is shown as a graphical display 1 in FIG. 1 and displays an operator station client 2 of a control system 9 of a technical installation configured as a process installation to an operator of the process installation for the purpose of operator control and monitoring of the technical installation. The operator station client receives the visualization information required herefor from an operator station server 3 of the control system 9 (cf. FIG. 4).

An installation image 4 is shown in the user interface 1, which in turn comprises a plurality of graphical representations of individual process objects of the process installation (inter alia, e.g., boiler, pump, and/or valve). The operator can select elements of the user interface 1, which are to be used within the scope of a subsequent modification of the graphical user interface 1. A first element 5 represents a temporal course of process measured values. A second element 6 represents “faceplates” of process objects, via which the operator can perform operator control and monitoring of the process objects.

The operator deposits the two elements 5, 6 (graphically) in a selection service 7 (more precisely: in its graphical interface). This means that the respective element 5, 6 is opened and shown again in the graphical user interface 1, if a specific condition is present at a subsequent point in time. In the selection window 8, the operator can determine the condition under which this opening is to occur. Therefore, he/she can define, for instance, that the first element 5 is then always opened if a standard installation image 8 (a “start screen”) is opened. The second element 6 can then be opened and shown for instance if a specifiable alarm sounds.

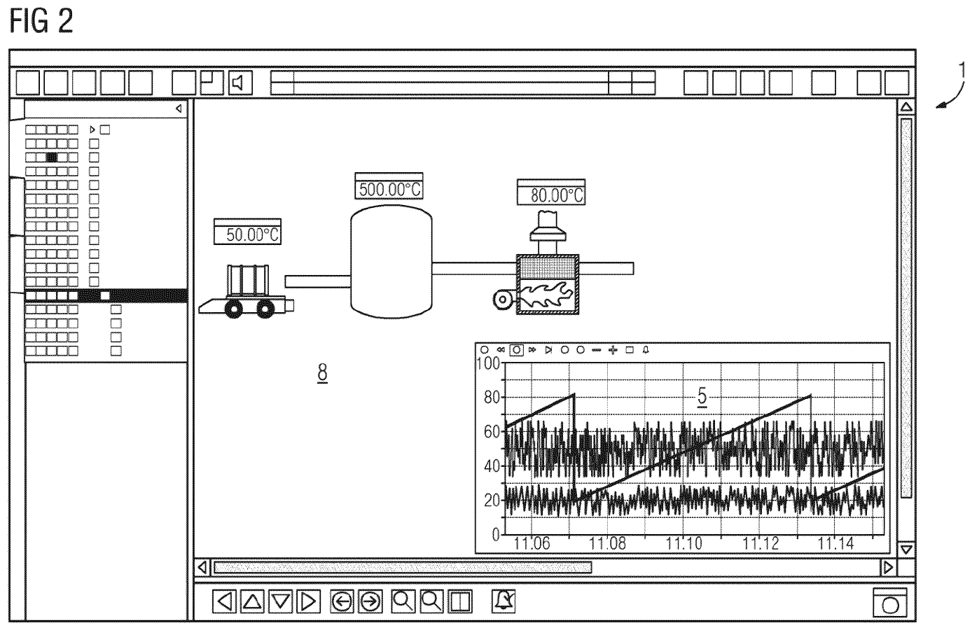

FIG. 2 shows such a standard installation image 8, the opening of which by the operator (or by a further operator) automatically triggers the opening of the first element 5. Contrary to the prior art, the operator need not laboriously perform this manually, which significantly simplifies the operator control and monitoring of the process installation. The opening of the standard installation image 8 represents an event or a condition, the fulfillment of which triggers the operator station client 2 to perform a modification of the graphical display, i.e., an opening of the first element 5.

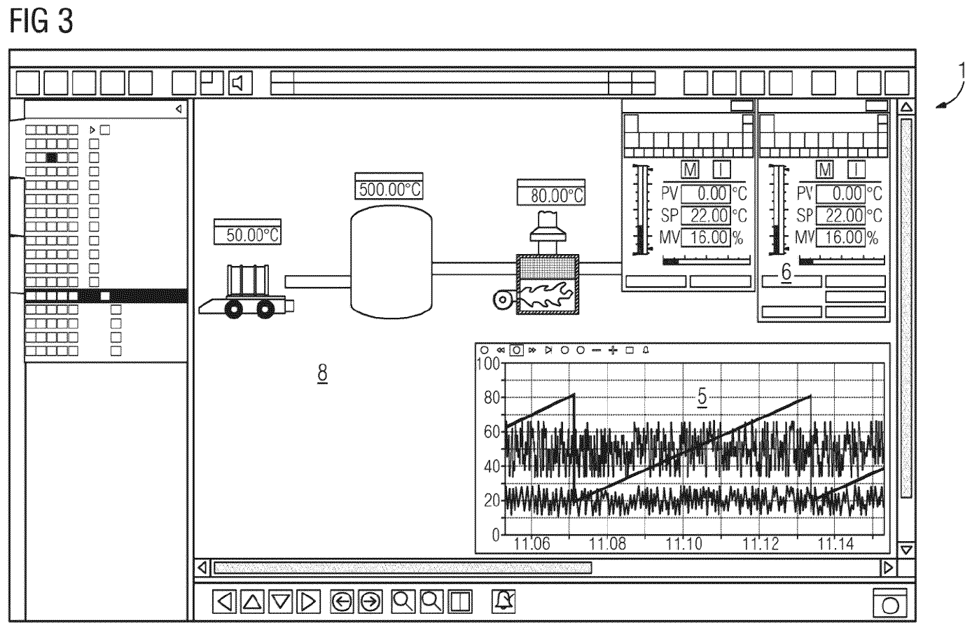

FIG. 3 shows by comparison with FIG. 2 in addition a visually represented second element 6, which has been automatically opened by the operator station client 2 as a result of the event/the condition of an occurring alarm message.

FIG. 4 shows a schematic representation of the control system 9 for the process installation. The control system 9 comprises the previously already cited operator station client 2 and the operator station server 3. The operator station server 3 and the operator station client 2 are connected to one another and optionally connected to further components of the control system 9 (not shown), such as an engineering station server or an archive server, via a terminal bus 10.

For purposes of operator control and monitoring via the operator station client 2, a user or operator can access the operator station server 3 via the terminal bus 10. The terminal bus 10 can be formed as an Industrial Ethernet, for instance, without being restricted thereto.

The operator station server 3 has a device interface 11, which is connected to an installation bus 12. By way of this device interface 11, the operator station server 3 can communicate with an automatic device 13 (not shown) and with optionally available further components of the process installation such as peripheral devices (not shown). The installation bus 12 can be formed as an Industrial Ethernet, for instance, but is not limited thereto.

A visualization service 14, a process image 15 and a memory 16 are (inter alia) implemented on the operator station server 3. The visualization service 14 integrated in the operator station server 3 initiates a transmission of visualization information to the operator station client 2. The operator station client 2 is configured to represent a graphical display, in particular installation images, for operator control and monitoring of the process installation.

A snapshot of the (signal) states of devices and/or applications (not shown in the figure) connected to the operator station server 3 are stored in the process image 15 of the operator station server 3. An alarm service 17 can read out alarm messages from the process image 15 and generate a graphical aggregation of the alarm messages, for instance, which the operator station client 2 can represent.

A user selection service 18 has access to the memory 16 of the operator station server 3. User profiles and personal settings of operators of the process installation can be stored there. These can also be accessible for further operators. The user selection service 18 has access to the selection service 7, in which the operator, as explained on the basis of FIGS. 1 to 3, specifies the requirements and conditions for the automatic graphical modification of the graphical display of the operator station client 2. Following receipt from the operator station client 2, it stores this data in the memory 16 of the operator station server 3.

A user interface service 19a, 19b monitors the graphical user interface 1 displayed by the operator station client 2 and conveys any modifications to the graphical user interface 1 performed by an operator to the user selection service 18.

Such a modification can be, for instance, an opening or closing of an installation image or any other element. The alarm service 17 conveys the occurrence of any alarm messages to the user selection service 18.

The user selection service 18 automatically checks whether the conditions stored in the memory 16 for a modification of the graphical display are fulfilled and, in the event that the condition is fulfilled, initiates the modification by triggering the operator station client 2 accordingly.

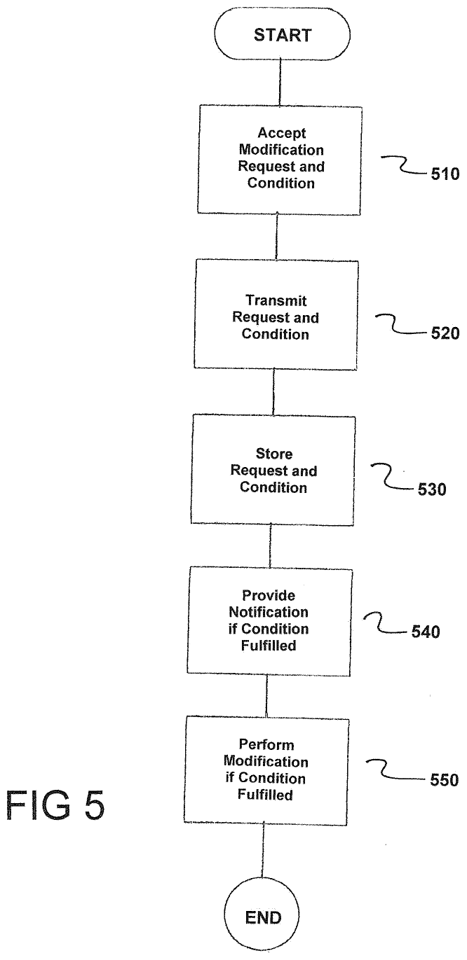

FIG. 5 is a flowchart of the method for operating a control system 9 of a technical installation including at least one operator station server 3 and at least one operator station client 2, where the at least one operator station server 3 is configured to transmit visualization information to the operator station client 2, and the operator station client 2 is configured to generate a graphical display 1 for an operator of the technical installation via the visualization information.

The method comprises a) accepting a request for a modification of the graphical display 1 and a condition for an application of the modification from an operator of the technical installation via the at least one operator station client 2, as indicated in step 510.

Next, b) the request and the condition from the operator station client 2 are transmitted to the at least one operator station server 3, as indicated in step 520.

Next, c) the request and the condition are stored in a memory 16 of the at least one operator station server 3, as indicated in step 530.

Next, d) a checked is automatically performed, via the operator station server 3, to determine whether the condition is fulfilled, and in an event the condition is fulfilled, the operator station client 2 is notified via the operator station server 3 that the condition is fulfilled, as indicated in step 540.

Next, e) in the event the condition is fulfilled, automatically performing the modification of the graphical display 1 is automatically performed via the at least one operator station client 2, as indicated in step 550.

Although the invention has been illustrated and described in more detail by the preferred exemplary embodiment, the invention is not restricted by the disclosed examples and other variations can be derived herefrom by the person skilled in the art without departing from the scope of protection of the invention.

Thus, while there have been shown, described and pointed out fundamental novel features of the invention as applied to a preferred embodiment thereof, it will be understood that various omissions and substitutions and changes in the form and details of the methods described and the devices illustrated, and in their operation, may be made by those skilled in the art without departing from the spirit of the invention. For example, it is expressly intended that all combinations of those elements and/or method steps that perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-11. (canceled)

12. A control system for a technical installation, the control system comprising:
at least one operator station server; and
at least one operator station client connected to the operator station server;
wherein the at least one operator station server is configured to transmit visualization information to the at least one operator station client;
wherein the at least one operator station client is configured to generate a graphical display for an operator of the technical installation via the visualization information;
wherein the at least one operator station client is further configured to accept a request for a modification of the graphical display from the operator and to transmit the request to the at least one operator station server;
wherein the at least one operator station server is further configured to store the request received by the at least one operator station client in a memory of the at least one operator station server;
wherein the at least one operator station client is further configured to accept a condition for the application of the modification of the graphical display which is specifiable by the operator and to transmit the condition to the operator station server;
wherein the at least one operator station server is further configured to store the condition in the memory of the at least one operator station server;
wherein the at least one operator station server is further configured to automatically check whether the condition is fulfilled and, in an event the condition is fulfilled, to notify the at least operator station client that the condition is fulfilled; and
wherein the at least one operator station client is further configured to automatically perform the modification of the graphical display in the event that the condition is fulfilled.

13. The control system as claimed in claim 12, wherein the graphical display represents an installation image of the technical installation.

14. The control system as claimed in claim 12, wherein the condition represents an event; and wherein the at least one operator station client is further configured to perform the modification of the graphical display when the event occurs.

15. The control system as claimed in claim 14, wherein the condition is produced from a logical link of a plurality of events.

16. The control system as claimed in claim 14, wherein the event represents one of an opening of an installation image, an opening of a faceplate of a technical object of the technical installation, an occurrence of an alarm, a parameter change of a technical object of the technical installation, an operating state of a technical object of the technical installation, an achievement of a specific state of a sequence of steps to be worked through by the technical installation or the achievement of a specific quality criterion during operation of the technical installation.

17. The control system as claimed in claim 12, wherein the condition represents one of presence of a specific identity, a specific role or a specific location of an operator operating the operator station client.

18. The control system as claimed in claim 12, wherein the technical installation comprises a production or process installation.

19. A method for operating a control system of a technical installation including at least one operator station server and at least one operator station client, the at least one operator station server being configured to transmit visualization information to the operator station client, and the operator station client being configured to generate a graphical display for an operator of the technical installation via the visualization information, the method comprising:
a) accepting a request for a modification of the graphical display and a condition for an application of the modification from an operator of the technical installation via the at least one operator station client;
b) transmitting the request and the condition from the operator station client to the at least one operator station server;
c) storing the request and the condition in a memory of the at least one operator station server;
d) automatically checking, via the operator station server, whether the condition is fulfilled, and in an event the condition is fulfilled, notifying the operator station client via the operator station server that the condition is fulfilled; and
e) in the event the condition is fulfilled, automatically performing the modification of the graphical display via the at least one operator station client.

20. The method as claimed in claim 12, wherein the technical installation comprises a production or process installation.
